(19) United States
(12) Patent Application Publication
(10) Pub. No.: US 2010/0140891 A1
(43) Pub. Date: Jun. 10, 2010

(54) GOLF BAG CART

(75) Inventor: Paul Lin, Tainan Hsien (TW)

Correspondence Address: TUROCY & WATSON, LLP, 127 Public Square, 57th Floor, Key Tower, CLEVELAND, OH, 44114, US

(73) Assignee: MACAUTO INDUSTRIAL CO., LTD, Tainan Hsien (TW)

(21) Appl. No.: 12/327,921

(22) Filed: Dec. 4, 2008

(51) Int. Cl. B62B 3/04; A63B 55/08

(52) U.S. Cl. 280/47.35; 248/96

(57) ABSTRACT

A retaining device for retaining a golf bag on a cart unit includes a mounting seat and a pair of grip members. The mounting seat is connected to the cart unit and has a pair of pivot connection parts spaced apart from each other. Each of the grip members includes a grip arm and a pivot control unit for connecting pivotally the grip arm to a respective one of the pivot connection parts. The pivot control unit is configured for operation in a bag retaining state, in which the pivot control unit permits pivoting movement of the grip arm relative to the mounting seat toward the other one of the grip members for clamping the golf bag and in which the pivot control unit prevents pivoting movement of the grip arm relative to the mounting seat away from the other one of the grip members.

### BACKGROUND OF THE INVENTION

1. Field of the Invention

This invention relates to a golf bag cart, and more particularly to a golf bag cart with a retaining device for retaining a golf bag on a cart unit.

2. Description of the Related Art

Referring to FIG. 1, a conventional golf bag cart 1 includes a cart frame 11, a set of wheels 12 mounted on a bottom part of the cart frame 11, and two strap units 13 for fastening a golf bag (not shown) onto the golf bag cart 1. The cart frame 11 includes a frame body 111, and a support member 112 mounted on a bottom end of the frame body 111. Each strap 13 includes a pair of straps 131 for strapping the golf bag onto the golf bag cart 1. However, frequent adjustment of the straps 131 is required in order to accommodate various sizes of the golf bags, which makes it inconvenient for use by golfers.

### SUMMARY OF THE INVENTION

Therefore, the object of the present invention is to provide a golf bag cart that is capable of overcoming the above-mentioned drawback of the prior art.

According to this invention, a golf bag cart includes a wheeled cart unit adapted for placing a golf bag thereon, and at least one retaining device for retaining the golf bag on the cart unit. The retaining device includes a mounting seat and a pair of grip members. The mounting seat is connected to the cart unit and has a pair of pivot connection parts spaced apart from each other to permit extension of the golf bag therebetween. Each of the grip members includes a grip arm and a pivot control unit for connecting pivotally the grip arm to a respective one of the pivot connection parts. The pivot control unit of each of the grip members is configured for operation in a bag retaining state, in which the pivot control unit permits pivoting movement of the grip arm relative to the mounting seat toward the other one of the grip members for clamping the golf bag between the grip arms of the grip members and in which the pivot control unit prevents pivoting movement of the grip arm relative to the mounting seat away from the other one of the grip members for retaining the golf bag on the cart unit.

### BRIEF DESCRIPTION OF THE DRAWINGS

These and other features and advantages of this invention will become apparent in the following detailed description of the preferred embodiment of this invention, with reference to the accompanying drawings, in which:

FIG. 1 is a perspective view of a conventional golf bag cart;

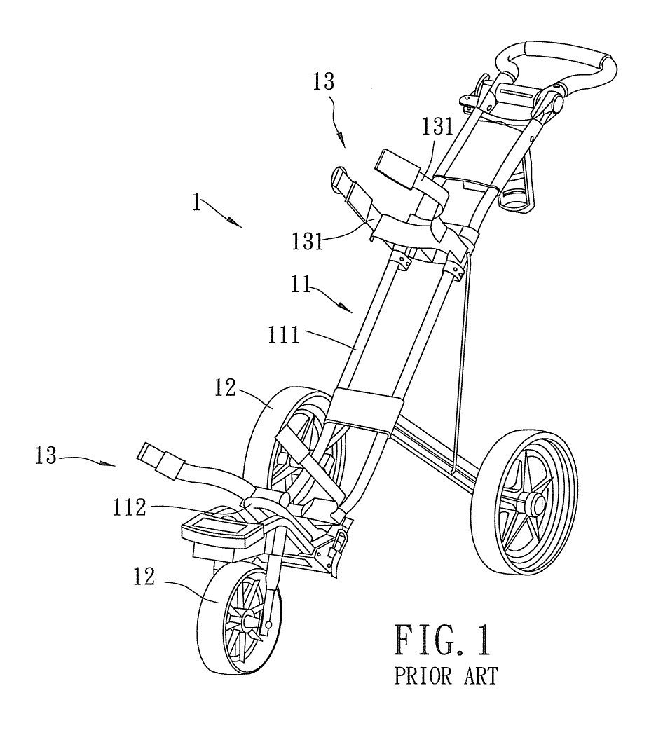

FIG. 2 is a perspective view of the preferred embodiment of a golf bag cart, which has a pair of retaining devices mounted thereon, in accordance with the present invention;

FIG. 3 is a schematic side view of the preferred embodiment to illustrate a golf bag mounted on the golf bag cart;

FIG. 4 is a schematic side view of the preferred embodiment to illustrate a folded state of a cart frame thereof according to the present invention;

FIG. 5 is a fragmentary exploded perspective view of one of the retaining devices of the preferred embodiment of the present invention;

FIG. 6 is a fragmentary sectional view of the retaining device to illustrate a pivot shaft disposed at a first position corresponding to a bag retaining state;

FIG. 7 is a fragmentary partly sectional view of the retaining device to illustrate a positioning component capable of moving between deep and narrow sections of a recess; and

FIG. 8 is a fragmentary sectional view of the retaining device to illustrate the pivot shaft disposed at a second position corresponding to a bag releasing state.

### DETAILED DESCRIPTION OF THE PREFERRED EMBODIMENT

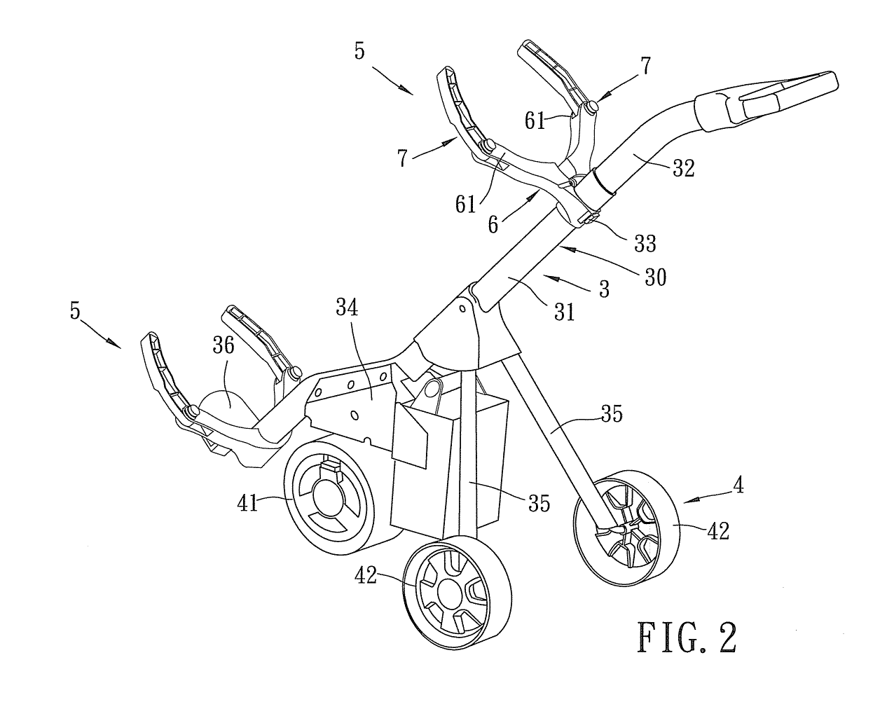

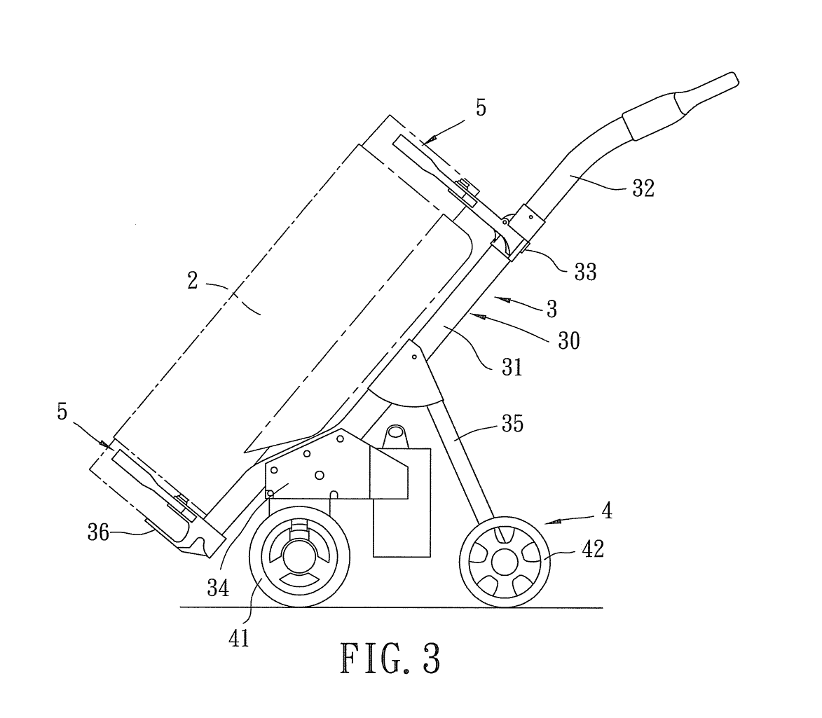

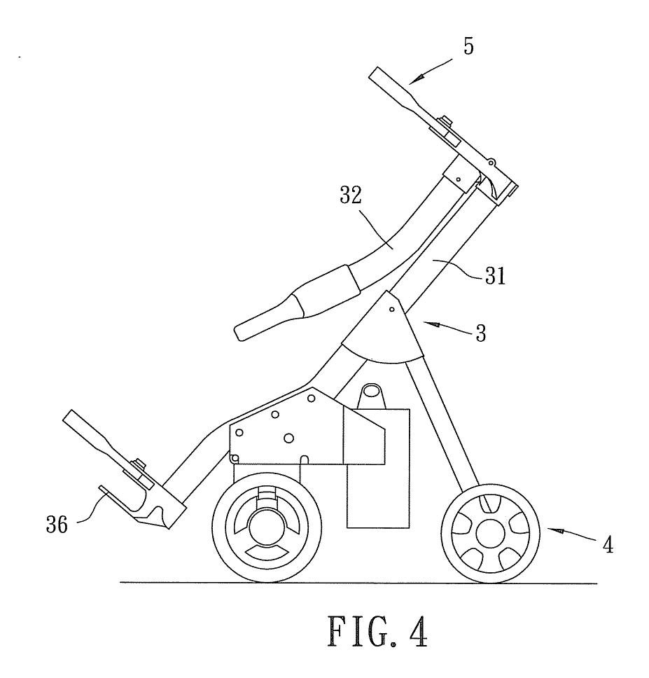

Referring to FIGS. 2 and 3, the preferred embodiment of a golf bag cart according to this invention comprises a wheeled cart unit 3 adapted for placing a golf bag 2 thereon, and at least one retaining device 5 for retaining the golf bag 2 on the cart unit 3. The wheeled cart unit 3 includes a cart frame 30 and a set of wheels 4 mounted on the cart frame 30. The cart frame 30 includes a pole member 31, a handle member 32 pivoted to the pole member 31, a release button 33 provided on the pole member 31, a front wheel support 34 disposed on the pole member 31, a pair of rear wheel supports 35 extending from the pole member 31, and a support plate 36 connected to a bottom end of the pole member 31. The set of wheels 4 includes a front wheel 41 mounted on the front wheel support 34, and a pair of rear wheels 42 respectively mounted on the rear wheel support 35. The handle member 32 can be folded (see FIG. 4) towards the pole member 31 upon operating the release button 33 for convenient and easy storage. In this embodiment, the golf bag cart includes two retaining devices 5 respectively disposed on the pole member 31 proximate to and distal from the support plate 36.

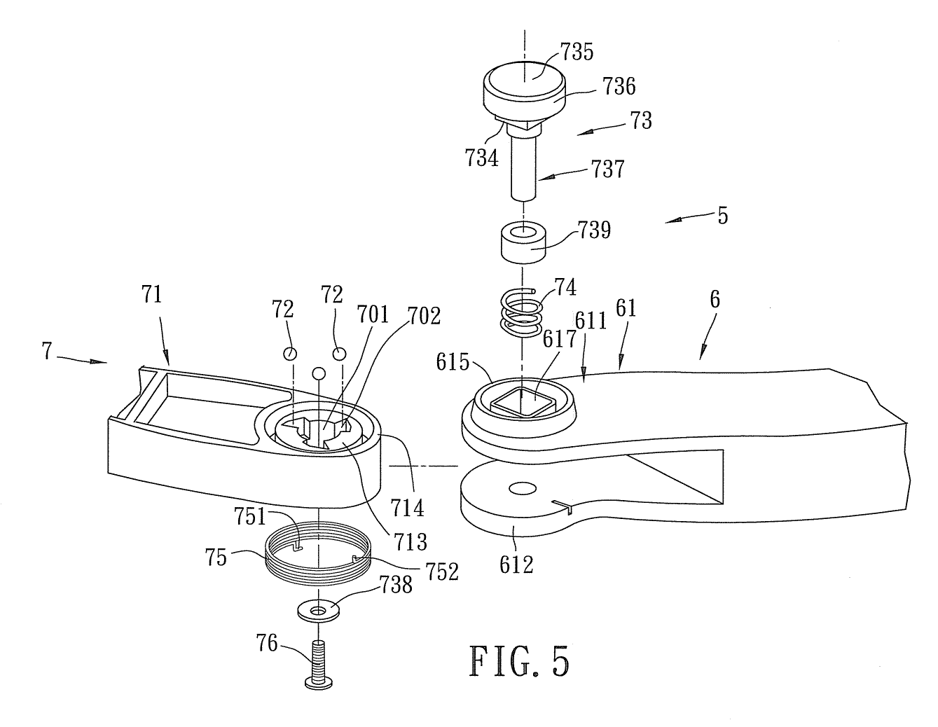

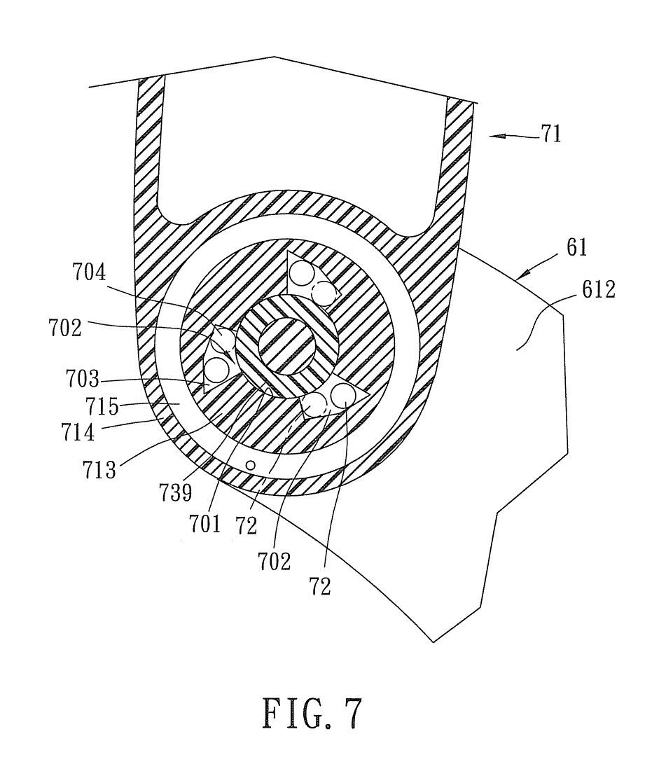

Each of the retaining device 5 includes a mounting seat 6 and a pair of grip members 7. The mounting seat 6 is connected to the pole member 31 and has a pair of pivot connection parts 61 spaced apart from each other to permit extension of the golf bag 2 therebetween. As best shown in FIGS. 5, 6, and 7, each of the grip members 7 includes a grip arm 71 and a pivot control unit 73 for connecting pivotally the grip arm 71 to a respective one of the pivot connection parts 61.

Each of the grip members 7 further includes an urging member 75 for urging the grip arm 71 to pivot toward the other one of the grip members 7. The urging member 75 is a torsion spring in this embodiment, and has a first end 751 connected to the mounting seat 6 and a second end 752 connected to the grip arm 71. The grip arm 71 of each of the grip members 7 is formed with a pivot hole 701 that defines a pivot axis (X), and three recesses 702 disposed radially outward relative to the pivot hole 701 and in spatial communication with the pivot hole 701. Further, the grip arm 71 has an inner wall part 713 formed with the pivot hole 701 and the recesses 702, an outer wall part 714 surrounding the inner wall part 713, and a connecting wall part 715 interconnecting the inner and outer wall parts 713, 714 in radial directions relative to the pivot axis (X). The inner wall part 713, the outer wall part 714, and the connecting wall part 715 cooperate to confine a chamber 716 for accommodating the urging member 75.

Each recess 702 has a deep section 703 and a shallow section 704 angularly adjacent to the deep section 703. Each of the grip members 7 further includes three positioning components 72 movably and respectively disposed in the recesses 702. Each positioning component 72 is a ball component in this embodiment and has a dimension or diameter that is slightly smaller than a radial depth of the deep section 703 and that is slightly larger than a radial depth of the narrow section 704. The pivot control unit 73 includes a pivot shaft 737 that extends through the respective one of the pivot connection parts 61 and into the pivot hole 701 in the grip arm 71.

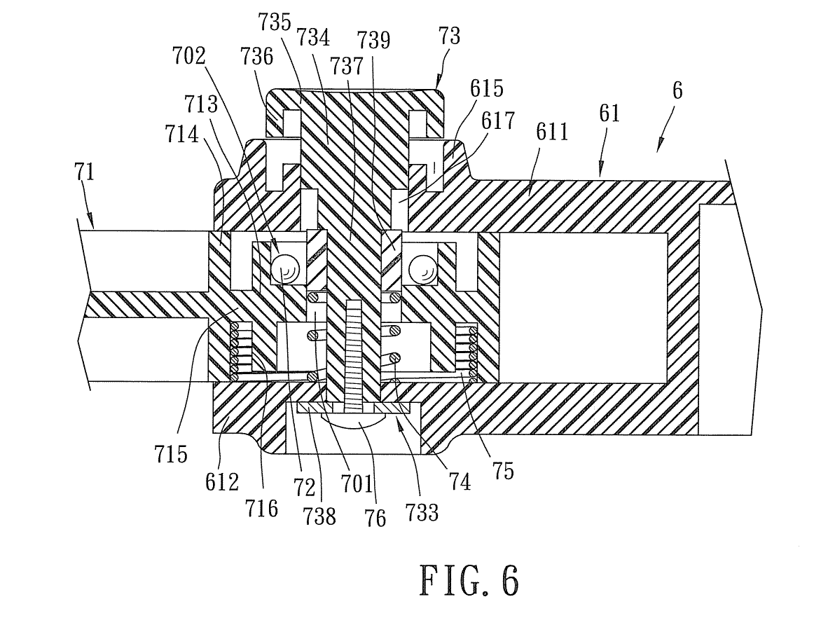

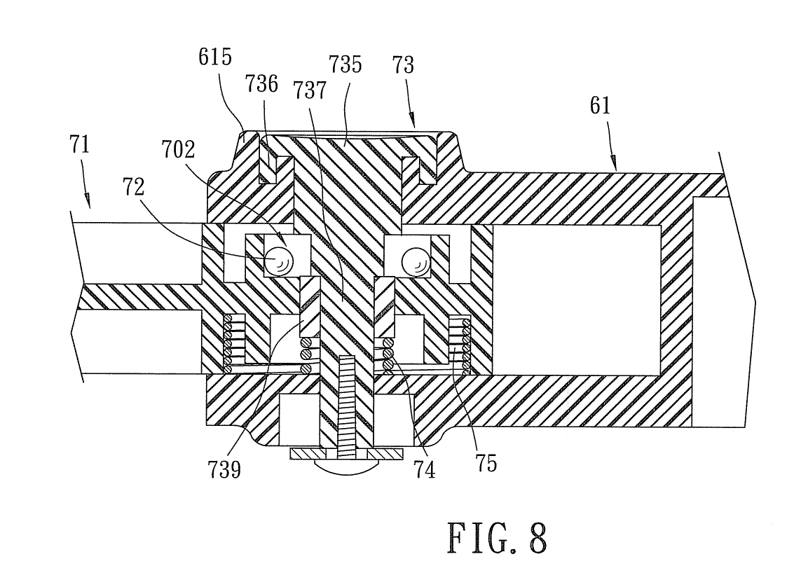

The pivot control unit 73 of each of the grip members 7 is configured for operation in a bag retaining state. The pivot shaft 737 has an engaging section 739 in the form of a ring fixed sleeved on the pivot shaft 737 and aligned with the recesses 702 when the pivot control unit 73 is operated in the bag retaining state. In addition, the pivot shaft 737 of each of the pivot control units 73 is movable along the pivot axis (X) relative to the respective one of the pivot connection parts 61 between a first position (see FIG. 6) corresponding to the bag retaining state and a second position (see FIG. 8) corresponding to a bag releasing state. Each of the pivot connection parts 61 includes spaced apart first and second pivot lugs 611, 612. The grip arm 71 of each of the grip members 7 extends between the first and second pivot lugs 611, 612 of the respective one of the pivot connection parts 61. Each of the grip members 7 further includes a biasing member 74 in the form of a spring for biasing the pivot shaft 737 to the first position against the second pivot lug 612 such that the pivot control unit 73 is normally in the bag retaining state.

The first pivot lug 611 of each of the pivot connection parts 61 has an outer lug surface opposite to the second pivot lug 612, and is formed with a rectangular guide hole 617 along the pivot axis (X), and an outer wall 615 that surrounds the guide hole 617. The pivot shaft 737 of each of the pivot control units 73 further has a press section 735 and a rectangular guide section 734 between the press section 735 and the engaging section 739. The guide section 734 extends non-rotatably through the guide hole 617 in the first pivot lug 611 of the respective one of the pivot connection parts 61 and is movable along the pivot axis (X) relative to the first pivot lug 611. The press section 735 is formed with a skirt 736.

The second pivot lug 612 of each of the pivot connection parts 61 has an outer lug surface opposite to the first pivot lug 611. The pivot shaft 737 of each of the pivot control units 73 extends through the second pivot lug 612 of the respective one of the pivot connection parts 61 and further has a stop section 738 in the form of a washer that abuts against the outer lug surface of the second pivot lug 612 when the pivot shaft 737 is at the first position, and a fastener 76 for fastening the pivot control unit 73 to the respective one of the pivot connection parts 61. In the bag retaining state, the pivot control unit 73 permits pivoting movement of the grip arm 71 relative to the mounting seat 6 toward the other one of the grip members 7 and the positioning components 72 are movable to the deep sections 703 of the recesses 702 for clamping the golf bag 2 between the grip arms 71 of the grip members 7. On the other hand, under the same bag retaining state, the pivot control unit 73 prevents pivoting movement of the grip arm 71 relative to the mounting seat 6 away from the other one of the grip members 7 and the positioning components 72 are movable to the narrow sections 704 of the recesses 702 to engage the engaging section 739 of the pivot shaft 737 for retaining the golf bag 2 on the cart unit 3.

Referring to FIG. 8, if it is intended to release the golf bag 2 from the grip members 7, the press section 735 of the pivot shaft 737 of each of the pivot control units 73 is pressed to move the pivot shaft 737 to the second position, where the skirt 736 extends into the outer wall 615, abuts against the outer lug surface of the first pivot lug 611, and surrounds the guide hole 617 in the first pivot lug 611. At this moment, the engaging section 739 of the pivot shaft 737 is offset from the recesses 702 in the grip arm 71 so as to be unable to engage the positioning components 72 in the recesses 702 when the positioning components 72 are moved to the narrow sections 704 of the recesses 702 while the pivot control unit 73 is operated in the bag releasing state, thereby permitting pivoting movement of the grip arm 71 relative to the mounting seat 6 away from the other one of the grip members 7 to permit removal of the golf bag 2 from the cart unit 3. Upon releasing each of the grip members 7, the biasing member 74 biases the pivot shaft 737 to the first position such that the pivot control unit 73 returns to the bag retaining state (see FIG. 6).

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A golf bag cart comprising a wheeled cart unit adapted for placing a golf bag thereon, and at least one retaining device for retaining the golf bag on said cart unit, said retaining device including
a mounting seat connected to said cart unit and having a pair of pivot connection parts spaced apart from each other to permit extension of the golf bag therebetween, and
a pair of grip members, each including a grip arm and a pivot control unit for connecting pivotally said grip arm to a respective one of said pivot connection parts,
said pivot control unit of each of said grip members being configured for operation in a bag retaining state, in which said pivot control unit permits pivoting movement of said grip arm relative to said mounting seat toward the other one of said grip members for clamping the golf bag between said grip arms of said grip members and in which said pivot control unit prevents pivoting movement of said grip arm relative to said mounting seat away from the other one of said grip members for retaining the golf bag on said cart unit.

2. The golf bag cart as claimed in claim 1, wherein each of said grip members further includes an urging member for urging said grip arm to pivot toward the other one of said grip members, said urging member having a first end connected to said mounting seat and a second end connected to said grip arm.

3. The golf bag cart as claimed in claim 1, wherein:
said grip arm of each of said grip members is formed with a pivot hole that defines a pivot axis, and a recess disposed radially outward relative to said pivot hole and in spatial communication with said pivot hole, said recess having a deep section and a shallow section angularly adjacent to said deep section;
each of said grip members further includes a positioning component movably disposed in said recess, said positioning component having a dimension that is slightly smaller than a radial depth of said deep section and that is slightly larger than a radial depth of said narrow section;
said pivot control unit includes a pivot shaft that extends through the respective one of said pivot connection parts and into said pivot hole in said grip arm, said pivot shaft having an engaging section aligned with said recess when said pivot control unit is operated in the bag retaining state;
said positioning component is movable to said deep section of said recess to permit pivoting movement of said grip arm toward the other one of said grip members when said pivot control unit is operated in the bag retaining state; and
said positioning component is further movable to said narrow section of said recess to engage said engaging section of said pivot shaft, thereby preventing pivoting movement of said grip arm away from the other one of said grip members when said pivot control unit is operated in the bag retaining state.

4. The golf bag cart as claimed in claim 3, wherein said pivot shaft of each of said pivot control units is movable along the pivot axis relative to the respective one of said pivot connection parts from a first position corresponding to the bag retaining state to a second position corresponding to a bag releasing state, and
wherein said engaging section of said pivot shaft is offset from said recess in said grip arm so as to be unable to engage said positioning component in said recess when said positioning component is moved to said narrow section of said recess while said pivot control unit is operated in the bag releasing state, thereby permitting pivoting movement of said grip arm relative to said mounting seat away from the other one of said grip members to permit removal of the golf bag from said cart unit.

5. The golf bag cart as claimed in claim 4, wherein each of said pivot connection parts includes spaced apart first and second pivot lugs, said grip arm of each of said grip members extending between said first and second pivot lugs of the respective one of said pivot connection parts, each of said grip members further including a biasing member for biasing said pivot shaft to the first position against said second pivot lug such that said pivot control unit is normally in the bag retaining state.

6. The golf bag cart as claimed in claim 5, wherein said first pivot lug of each of said pivot connection parts has an outer lug surface opposite to said second pivot lug and is formed with a guide hole along the pivot axis, said pivot shaft of each of said pivot control units further having a press section and a guide section between said press section and said engaging section, said guide section extending non-rotatably through said guide hole in said first pivot lug of the respective one of said pivot connection parts and being movable along the pivot axis relative to said first pivot lug, said press section being formed with a skirt that abuts against said outer lug surface of said first pivot lug and that surrounds said guide hole in said first pivot lug when said pivot shaft is at the second position.

7. The golf bag cart as claimed in claim 5, wherein said second pivot lug of each of said pivot connection parts has an outer lug surface opposite to said first pivot lug, said pivot shaft of each of said pivot control units extending through said second pivot lug of the respective one of said pivot connection parts and further having a stop section that abuts against said outer lug surface of said second pivot lug when said pivot shaft is at the first position.

8. The golf bag cart as claimed in claim 2, wherein said grip arm has an inner wall part formed with said pivot hole and said recess, an outer wall part surrounding said inner wall part, and a connecting wall part interconnecting said inner and outer wall parts in radial directions relative to the pivot axis,
said inner wall part, said outer wall part and said connecting wall part cooperating to confine a chamber for accommodating said urging member.

9. The golf bag cart as claimed in claim 1, wherein said wheeled cart unit includes a cart frame and a set of wheels mounted on said cart frame, said cart frame including a pole member and a support plate connected to one end of said pole member, said golf bag cart comprising two of said retaining devices respectively disposed proximate to and distal from said support plate.
